(19) United States
(12) Patent Application Publication
(10) Pub. No.: US 2004/0234799 A1
(43) Pub. Date: Nov. 25, 2004

(54) Self-adhesive protective film for glass surfaces comprising a porous sio2 anti-reflection layer and use of the same

(76) Inventors: Nicolai Bohm, Hamburg (DE); Jobst-Waldemar Klemp, Schenefeld (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/477,659

(22) PCT Filed: Apr. 18, 2002
(86) PCT No.: PCT/EP02/04283

(30) Foreign Application Priority Data
May 17, 2001 (DE) 101 23 985.8

(51) Int. Cl. B32B 27/08

(52) U.S. Cl. 428/515; 428/500

(57) ABSTRACT

A self-adhesive protective film having a film backing to which a self-adhesive composition which comprises at least one copolymer of ethylene and vinyl acetate, the amount of vinyl acetate in the polyethylene-vinyl acetate being preferably at least 40% by weight, more preferably from 55 to 70% by weight, is applied and which self-adhesive composition further comprises polyalkylene glycols.

The invention relates to a self-adhesive protective film for protecting glass surfaces comprising a porous SiO₂ anti-reflection layer in order to preserve the latter from scratching following production until the eventual use thereof, during storage, transit, and assembly.

In the course of the current debate on sustainability, attention is increasingly being paid to regenerative energy sources. One method of sustainable energy production is solar technology, with which electricity can be obtained from photovoltaic cells and thermal energy from solar collectors. Such modules are conventionally covered with window glass in order to protect the active components against environmental influences. Particularly when the incident radiation strikes at an angle, some of the energetic radiation is reflected from the glass/air interface, reducing the efficiency. One appropriate technique to reduce the reflection from glass surfaces is to generate a porous layer of SiO₂ on glass, allowing the attainment of a sufficiently low refractive index in order to prevent reflection almost completely over a broad wavelength band through destructive interference.

With particular types of glass, borosilicate glass for example, this can be done by etching or, independently of the type of glass, by means of the sol-gel method. One example of the last-mentioned process is disclosed in DE 199 18 811 A1.

One drawback of such porous SiO₂ anti-reflection layers is their sensitivity in respect of mechanical influences. It therefore makes sense to protect the valuable and sensitive surfaces. One solution is represented by self-adhesive films, which are applied following production and remain on the sheet until the solar module is taken into operation. Since some time may elapse between the installation of the solar module and its being taken into operation, a protective article of this kind must be resistant to weathering, so as not to become brittle or to leave adhesive residues behind over a very large area when it is removed.

A protective film for this purpose does not have to be transparent; indeed, it has advantageously a white pigmentation, since in that way it protects the absorber against overheating, particularly in the case of solar collectors, before the solar module is taken into operation.

Protective films of this kind intended for temporary application are widespread for protecting the paint of new motor vehicles and are described for example in DE 195 32 220 A1 and EP 0 827 526 A1. They can likewise be bonded to glass surfaces and meet the criterion of weathering stability in an outstanding fashion. These films can be removed from window glass without tearing or residues of adhesive even after months of outdoor exposure.

Thus EP 0 519 278 A2 discloses an adhesive applied to a film which is used in turn to protect automobiles. The pressure-sensitive adhesive is based on polyisobutylene rubber which has a dynamic elasticity modulus of from 2×10⁵ to 7×10⁶ dyn/cm², corresponding in Si units to a figure of from 2×10⁴ to 70×10⁴ Pa, at 60° C. The adhesive may further be blended with a silicone oil or with a low molecular mass acrylic polymer.

DE 196 35 704 A1 describes a self-adhesive surface protective film comprising polyolefins, with a polyethylene-vinyl acetate (EVA) adhesive having a vinyl acetate content of from 40 mol % to 80 mol %, in particular 70 mol %, and having a loss angle tan δ of from 0.6 to 1.0, measured at a temperature of 60° C. and a frequency of 10⁻² Hz, and from 0.4 to 0.7, measured at a temperature of 60° C. and a frequency of 10 Hz. EVA in the form claimed has good initial adhesion to paint and good paint compatibility.

Described in numerous instances have been window films, which alter the properties of the sheets over which they are stuck. They do this, for example, by a darkening tint, IR absorption for heat insulation, or anti-reflection coatings.

U.S. Pat. No. 5,925,453 A describes for example a window film which reflects light and absorbs IR and can be adhered to the inside of curved auto glass. As possible support materials, which are also miscible with the IR absorbent, preference is given, inter alia, to polyolefins such as polyethylene and polypropylene, polyvinyl chloride, and polyesters such as polyethylene terephthalate and polybutylene terephthalate. Possible adhesives recited are self-adhesive compositions, including synthetic rubbers such as styrene-butadiene rubber, polyisobutylene, styrene block copolymers, and polyethylene-vinyl acetate, and also heat- and moisture-activable compositions.

The film described, however, has no protective function, primarily since it is applied from the inside to the concave areas of glass. Articles of this kind are normally intended for long-term bonding and there is therefore a different emphasis on the requirements they must meet.

Using these films on glass with an SiO₂ anti-reflection layer, in contrast, leads to the surprising finding that the bond strength to untreated window glass is extremely high, so that in the case of commercially customary products there are generally excessive residues of adhesive or even instances of tearing of the film.

After those few self-adhesive compositions which can be removed without residue at all, with great care, have been peeled away, or after the removal of adhesive residues using suitable solvents such as petroleum spirit or acetone, the SiO₂ anti-reflection layer has nevertheless undergone an irreversible change. Its optical appearance is virtually the same as that of untreated window glass; in other words, the anti-reflection effect has decreased sharply.

The polymers of the self-adhesive composition or other constituents of the self-adhesive composition, such as resins, plasticizers or the like, migrate deep into the micropores of the SiO2 anti-reflection layer and can no longer be removed completely from them.

It is an object of the invention to provide a self-adhesive protective article for glass surfaces having a porous SiO₂ anti-reflection layer and does not exhibit the disadvantages of the prior art, or not to the same extent. In particular it ought to be possible to remove the article from the porous SiO₂ anti-reflection layer in such a way that even after months of outdoor exposure there are no irreversible changes in the anti-reflection effect at all. Remanent changes in the anti-reflection effect ought to be completely removable with customary household solvents (for example, methylated spirit (ethanol)) without exposing the sensitive porous SiO2 anti-reflection layer to strong mechanical action.

This object is achieved by a self-adhesive protective film as recorded in the main claim. The subclaims provide advantageous developments of the protective film and also provide for its use.

The invention accordingly provides a self-adhesive protective film for mechanically protecting glass surfaces comprising porous SiO₂ anti-reflection layers, having a film backing and applied to the backing a self-adhesive composition which comprises at least one copolymer of ethylene and vinyl acetate, the amount of vinyl acetate in the polyethylene-vinyl acetate being preferably at least 40% by weight, more preferably from 55 to 70% by weight, and has been additived with polyalkylene glycols.

The additive penetrates preferentially into the pores of the porous SiO₂ anti-reflection layer, so that none of the constituents of the adhesive are able to enter the pores, and can be removed straightforwardly and without residue from the pores of the, porous SiO₂ anti-reflection layer using customary household solvents, ethanol for example.

In one advantageous embodiment of the invention the formulation of the self-adhesive composition comprises a base polymer of polyethylene-vinyl acetate (EVA) having a vinyl acetate fraction of from 40 to 80% by weight and a melt index MFI in accordance with ISO 1133 (A/4) of from 0.5 to 25 g/10 min at 190° C. and 2.16 kg which has been blended with a polyether having a fraction of from 1 to 35% by weight of the form

XO—[(CH₂)₄—O]—Y (1)

or

XO—[(CH(CH₃)—CH₂—O]—Y (2)

having a molecular weight average M_{w}=200 to 100 000 g/mol, where X and Y are selected from the group consisting of H—, (CₙH₂ₙ₊₁) — with n=1 to 20, CH₂═CHCO—, CH₃CH(NH₂)CH₂—, 2,3-epoxypropyl-, C₆H₅—CO—, and CH₂═C(CH₃)—CO—.

In one further preferred embodiment the adhesive composition is made up as follows:

from 65 to 98% by weight, preferably from 75 to 95% by weight EVA, it being possible for the EVA to have in particular a VA fraction of from 40 to 80% by weight, preferably from 50 to 65% by weight, and a melt index MFI of from 0.5 to 25 g/10 min at 190° C. and 2.16 kg, preferably from 1 to 5 g/10 min at 190° C. and 2.16 kg, or mixtures of different EVA grades within these ranges, and

from 2 to 35% by weight, preferably from 5 to 20% by weight of a polyether of type (1) or (2) having a molecular weight average M_{w}=200 to 100 000 g/mol, preferably 1000 to 20 000 g/mol.

In an additional and highly advantageous embodiment of the invention the adhesive composition is composed of polyethylene-vinyl acetate having a VA fraction of from 40 to 80% by weight, preferably from 45% to 70% by weight, and an addition of (1) or (2) of from 0 to 35% by weight, preferably from 0 to 20% by weight.

By polyalkylene glycols (polyglycols, polyglycol ethers) the skilled worker understands predominantly linear but in part also branched polyethers of the general formula

HO[R¹—O—R²—O]ₙH

i.e., polymers having terminal hydroxyl groups.

The industrially important representatives of these polyether-polyols are the polyethylene glycols [polyethylene oxides, R1=R2=(CH2)2], polypropylene glycols [polypropylene oxides, R1=R2=CH2—CH(CH3)], and polytetramethylene glycols [polytetrahydrofurans, R1=R2=(CH2)4], which are prepared by ring-opening polymerization of ethylene oxide, propylene oxide, and tetrahydrofuran, respectively.

Since the synthesis of the polyalkylene glycols can also be conducted as a living polymerization (see living polymers), polyalkylene glycols can also be obtained as block copolymers of the type

HO(R¹—O)ₓ—(R²—O)_{y}H

[e.g., with R1=(CH2)2 and R2=CH2—CH(CH3) and/or (CH2)4].

The self-adhesive composition is advantageously additived with polybutylene glycol and/or polypropylene glycol, in particular at from 5 to 20% by weight (based on the self-adhesive composition), very preferably at from 8 to 15% by weight (based on the self-adhesive composition).

Polyethylene glycols (polyethylene oxides) is the name for polyalkylene glycols which belong to the class of the polyethers and have the general formula

H[O—CH₂—CH₂]ₙOH

Polyethylene glycols are prepared industrially by anionic ring-opening polymerization of ethylene oxide (oxirane) usually in the presence of small amounts of water.

Depending on the reaction regime they have molar masses in the range of approximately 200-5 000 000 g/mol, corresponding to degrees of polymerization Pn of approximately 5 to >100 000.

In a wider sense, products having a Pn=2-4 (di-, tri-, and tetraethylene glycol) are also included in the polyethylene glycols; they can be prepared with molecular uniformity, whereas the polyethylene glycols with higher molar masses are polydisperse.

Liquid products having molar masses <approximately 25 000 g/mol are termed actual polyethylene glycols, abbreviation PEG, while the higher molecular mass solids (melting point approximately 65° C.) are called polyethylene oxides, abbreviation PEOX.

High molecular mass polyethylene oxides possess an extremely low concentration of reactive hydroxyl endgroups and therefore exhibit only weak glycol properties. Branched polyadducts of ethylene glycol with polyhydric alcohols are also termed polyethylene glycols.

Polypropylene glycols (abbreviation PPG) constitute liquid, viscous polyalkylene glycols of the general formula

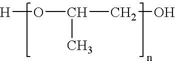

of MR 250-4000, whose low molecular mass representatives are miscible with water, whereas the high molecular mass polypropylene glycols, in contrast, are virtually insoluble in water. Very high molecular mass polypropylene glycols are referred to as polypropylene oxides.

The polypropylene glycol come about by ring-opening polymerization of propylene oxide. As glycol ethers in the wider sense they are counted among the polyethers. The simplest representatives of the polypropylene glycols are di-, tri-, and tetrapropylene glycol.

Suitable backings include very especially unoriented films, which have sufficient flexibility to be able to be bonded to curved surfaces almost without creases. Particularly suitable polymers include polyethylene, polypropylene, propylene-ethylene copolymers or mixtures of such.

These backings require UV stabilization in order to ensure that the film has a long performance life under outdoor weathering. Particularly appropriate are HALS light stabilizers such as, for example, dimethyl succinate polymer with 4-hydroxy-2,2,6,6-tetramethyl-1-piperidineethanol (CAS No. 65447-77-0), bis(2,2,6,6-tetramethyl-4-piperidinyl) sebacate (CAS No. 52829-07-9) or poly[[6-[(1,1,3,3-tetramethylbutyl)amino]-1,3,5-triazine-2,4-diyl][[(2,2,6,6-tetramethyl-4-piperidyl)]imino]hexamethylene[(2,2,6,6-tetramethyl-4-piperidyl)imino]] (CAS No. 70624-18-9).

The amount of the light stabilizers should be at least 0.15%, preferably at least 0.30%, by weight based on the backing film.

Additional protection from light is achieved through fillers such as titanium dioxide, which hence additionally gives the film a white coloring, which in the case of opaque surfaces is frequently desirable.

In one particularly advantageous embodiment of the invention the backing is an unoriented film of from 30 to 120 μm in thickness, preferably from 35 to 80 μm, in thickness, which is composed of a random propylene-ethylene copolymer having an ethylene fraction of from 2 to 10% by weight, preferably from 4 to 8% by weight, and containing more than 0.3% by weight, preferably more than 0.5% by weight, of a light stabilizer.

Preferably between self-adhesive composition and film there in a suitable primer for anchoring, particular suitability being possessed by EVA grades having a VA fraction of from 20 to 50% by weight, preferably from 20 to 40% by weight.

The thickness of the primer is in particular from 5 to 20 μm, preferably from 5 to 15 μm. A corona pretreatment as well is effective when coating is carried out from solution. Advantageously the primer is coextruded with the backing layer.

Even if the self-adhesive composition has a reduced bond strength to its own reverse, it may for the purpose of greater ease of unwind, particularly of very wide protective films in rolled-up form of up to 2 m in width, for there to be an additional release coating, whose active ingredients may be, for example, silicones or waxes. Otherwise, during the unrolling of the film, which is deliberately of stretchable design, there may already be irreversible distortion.

The self-adhesive composition is applied to the film preferably in a coatweight of from 8 to 50 g/m², more preferably from 10 to 30 g/m². This ensures a sufficient cushion of adhesive to flow out flush and exhibits the best compatibility with sensitive surfaces, without residues of adhesive.

The self-adhesive composition can be processed both from solution and from the melt, i.e., as a hotmelt, or by coextrusion.

The outstanding properties of the self-adhesive protective film permit its use on glass surfaces comprising a porous SiO₂ anti-reflection layer, in a particularly outstanding way.

The concept of the inventions then, likewise embraces a self-adhesive composition which comprises at least one copolymer of ethylene and vinyl acetate, the amount of vinyl acetate in the polyethylene-vinyl acetate being preferably at least 40% by weight, more preferably from 55 to 70% by weight, and has been additived with polyalkylene glycols.

The self-adhesive formulation comprises in particular a base polymer of polyethylene-vinyl acetate (EVA) having a vinyl acetate fraction of from 40 to 80% by weight and a melt index MFI in accordance with ISO 1133 (A/4) of from 0.5 to 25 g/10 min at 190° C. and 2.16 kg which has been blended with a polyether having a fraction of from 1 to 35% by weight of the form

XO—[(CH₂)₄—O]—Y (1)

or

XO—[(CH(CH₃)—CH₂—O]—Y (2)

having a molecular weight average M_{w}=200 to 100 000 g/mol, where X and Y are selected from the group consisting of H—, (CₙH₂ₙ₊₁)— with n=1 to 20, CH₂=CHCO—, CH₃CH(NH₂)CH₂—, 2,3-epoxypropyl-, C₆H₅—CO—, and CH₂=C(CH₃)—CO—.

In one preferred embodiment the composition of the adhesive is as follows:

from 65 to 98% by weight, preferably from 75 to 95% by weight EVA, it being possible for the EVA to have in particular a VA fraction of from 40 to 30% by weight, preferably from 50 to 65% by weight, and a melt index MFI of from 0.5 to 25 g/10 min at 190° C. and 2.16 kg, preferably from 1 to 5 g/10 min at 190° C. and 2.16 kg, or mixtures of different EVA grades within these ranges, and

from 2 to 35% by weight, preferably from 5 to 20% by weight of a polyether of type (1) or (2) having a molecular weight average M_{w}=200 to 100 000 g/mol, preferably 1000 to 20 000 g/mol.

The EVA in the form described constitutes the polymer framework of the adhesive, with a moderately pronounced tack on polished or glossy metal, plastic, glass, and paint surfaces and a rapidly increasing bond strength thereto which takes on its ultimate level within a few days or more quickly under the effect of heat.

Since the polymer skeleton is chemically uncrosslinked and on account of its monomer ratio has only a very low level of crystallinity, the molecular weight, which correlates directly with the MFI, occupies a critical position in terms of the cohesiveness of the adhesive. An MFI of from 1 to 5 is considered a favorable figure. Admixing a portion of the EVA with an MFI of up to 25, however, they contribute to improving the flow properties if the adhesive is to be applied from the melt or is to be coextruded together with a backing.

The addition of the polyethers described has the effect of reducing the bond strength while retaining the required initial tack, ageing stability, health and environmental safety, lack of staining even of white substrates, and lack of residue on the overstuck surfaces after demasking. Depending on the sensitivity of the surfaces to be protected, different molar masses are found suitable for preventing migration and in tandem therewith a swelling, particularly of plastic and paint surfaces.

The unwind behavior of the protective films produced with this adhesive and wound up into rolls is also markedly reduced relative to that of a straight EVA composition. Depending on the fraction of the admixed polyether the bond-strength-reducing effect can be steplessly regulated.

The adhesive tape can easily be peeled from the porous SiO₂ anti-reflection layer even after months of outdoor exposure and the deposit which remains can be removed completely using simple means.

The intention of the text below is to illustrate the invention, with reference to examples, but without wishing thereby to restrict it.

### EXAMPLES

All of the example films were produced by coating a corona-pretreated polyethylene backing 60 μm thick (composed of 90 percent by weight HDPE with a melt flow rate at 190° C./2.16 kg (ISO 1133) of 0.2 g/10 min, 9.7 percent by weight titanium dioxide, and 0.3 percent by weight Tinuvin 770, Ciba-Geigy) with the solutions of the individual adhesive formulas.

The thickness of the coat of pressure sensitive adhesive after drying was in each case 20 μm, giving the specimens an overall thickness of 80 μm.

The constitutions of the self-adhesive compositions of the examples are listed in the following table.

| | Examples | | | Counterexamples | | | |
|---|---|---|---|---|---|---|---|
| Adhesive constituents | 1 | 2 | 3 | 4 | 5 | 6 | 7 |
| Polybutylene glycol | 10 | | | | | 10 | |
| (linear, 2900 g/mol) | | | | | | | |
| Polybutylene glycol | | 15 | | | | | |
| (linear, 1000 g/mol) | | | | | | | |
| Polypropylene glycol | | | 8 | | | | |
| (linear, 4200 g/mol) | | | | | | | |
| Polyethylene-vinyl | 90 | 85 | | 100 | | | |
| acetate 50% VA fraction | | | | | | | |
| polyethylene-vinyl | | | 92 | | | | |
| acetate 60% VA fraction | | | | | | | |
| Polyacrylate self- | | | | | 100 | 90 | |
| adhesive composition* | | | | | | | |
| Natural rubber self- | | | | | | | 100 |
| adhesive composition** | | | | | | | |

percent by weight in example
adhesive
*Copolymer of 48 percent by weight 2-ethylhexyl acrylate, 48 percent by weight n-butyl acrylate, and 4 percent by weight acrylic acid.
**Compounded from 50 percent by weight natural rubber, 20 percent by weight rosin, 15 percent by weight hydrocarbon resin, 10 percent by weight zinc oxide, and 5 percent by weight mineral oil.

### Test Procedure

As the test adhesion substrate use was made of glass plates coated on both sides with a porous SiO₂ anti-reflection layer applied in analogy to the method described in DE 199 18 811 A1.

The reaction temperature was 800° C. The glass sample coated on one side for reference purposes (single-side AR) was obtained by masking one side of the immersed sheet with a protective film which was peeled away together with the adhering sol prior to the high-temperature treatment.

For testing, strips of the example specimens 20 cm long and 5 cm wide were bonded to the glass plates and stored at 90° C. for three days. After a conditioning period under standard conditions (23±1° C., 50±5% RH) over 24 hours the following tests were conducted.

To determine the bond strength the strips were peeled at an angle of 180° and a speed of 0.3 min by means of a tensile testing machine.

The formerly overstuck area was subsequently inspected for residues of adhesive by cohesive fracture within the composition or adhesive fracture to the backing.

In the case of the example specimens where removal was possible without residues of adhesive, the strip track which was visible was overwiped three times using a cloth soaked in ethanol. In the case of example specimens with residues of adhesive, these residues were first removed with petroleum spirit or acetone and then the visible strip track was likewise overwiped three times with a cloth soaked in ethanol. A grating spectrophotometer was then used to measure the transmission of the solar spectrum at the formerly overstock site.

In the overview below the results have been compiled in table form.

Result overview

| | Bond strength | Adhesive | Transmission |
|---|---|---|---|
| | in N/cm | residues | in % |
| Ex. 1 | 2.1 | none | 95.7 |
| Ex. 2 | 2.5 | none | 95.9 |
| Ex. 3 | 1.9 | none | 95.6 |
| C.-Ex. 4 | 7.2 | over full | 93.3 |
| | | area | |
| C.-Ex. 5 | 3.5 | over full | 93.0 |
| | | area | |
| C.-Ex. 6 | 9.5 | over full | 92.8 |
| | | area | |
| C.-Ex. 7 | 8.7 | over full | 93.2 |
| | | area | |
| Without overstick | — | — | 95.8 |
| Single-side AR | — | — | 93.0 |
| Window glass | — | — | 89.9 |

It is clearly evident that the examples in accordance with the invention exhibit a bond strength which allows straightforward removal of the protective films. They therefore do not leave behind any residues of adhesive as a result of cohesive fracture within the adhesive or adhesive fracture to the backing.

In the case of the specimens in accordance with the invention the anti-reflection effect is fully reestablished following treatment with ethanol.

As regards the transmission figures for the counterexamples it should be noted that only one side was overstuck, which is why only one side of the anti-reflection layer is affected by the bonds formed over it while the other side was still intact. The corresponding reference example, therefore, is the single-sidedly anti-reflection-coated glass (“single-side AR”). With the counterexamples the reestablishment of the anti-reflection effect by the customary household solvent ethanol (methylated spirit) did not work.

1. A self-adhesive protective film having a film backing to which a self-adhesive composition which comprises at least one copolymer of ethylene and vinyl acetate is applied and which self-adhesive composition comprises polyalkylene glycols.

2. The self-adhesive protective film as claimed in claim 1, wherein the self-adhesive composition comprises a base polymer of polyethylene-vinyl acetate (EVA) having a vinyl acetate fraction of from 40 to 80% by weight and a melt index MFI in accordance with ISO 1133 (A/4) of from 0.5 to 25 g/10 min at 190° C. and 2.16 kg and wherein said polyalkylene glycol is a polyether having a fraction of from 1 to 35% by weight of the formula
XO—[(CH₂)₄—O]—Y (1)
or
XO—[(CH(CH₃)—CH₂—O]—Y (2)
having a weight average molecular weight M_{w}=200 to 100 000 g/mol, where X and Y are selected from the group consisting of H—, (CₙH₂ₙ₊₁)— with n=1 to 20, CH₂═CHCO—, CH₃CH(NH₂)CH₂═, 2,3-epoxypropyl-, C₆H₅—CO—, and CH₂=C(CH₃)—CO—.

3. The self-adhesive protective film as claimed in claim 2, wherein the self-adhesive composition is made up of: from 65 to 98% by weight EVA, the EVA having a VA fraction of from 40 to 80% by weight and a melt index MFI of from 0.5 to 25 g/10 min at 190° C. and 2.16 kg, or mixtures of different EVA grades within these ranges, and from 2 to 35% by weight of a polyether of type (1) or (2) having a weight average molecular weight M_{w}=200 to 100 000 g/mol.

4. (canceled)

5. The self-adhesive protective film as claimed in claim 1, wherein the self-adhesive composition comprises polybutylene glycol and/or polypropylene glycol, in an amount of from 5 to 20% by weight, based on the weight of self-adhesive composition.

6. The self-adhesive protective film as claimed in claim 1, wherein the film of the backing is an unoriented film and is composed of polyethylene, polypropylene, propylene-ethylene copolymers or mixtures thereof.

7. The self-adhesive protective film as claimed in claim 1, wherein said backing film comprises light stabilizers, in an amount of at least 0.15% by weight, based on the film weight.

8. The self-adhesive protective film as claimed in claim 7, wherein the backing is an unoriented film of from 30 to 120 μm in thickness, which is composed of a random propylene-ethylene copolymer having an ethylene fraction of from 2 to 10% by weight, and containing more than 0.3% by weight of a light stabilizer.

9. The self-adhesive protective film as claimed in claim 1, wherein between the self-adhesive composition and the film there is a primer of EVA having a VA fraction of from 20 to 50% by weight.

10. The self-adhesive protective film as claimed in claim 1, wherein the self-adhesive composition is applied to the film as a coating in the amount of from 8 to 50 g/m².

11. A method of protecting glass surfaces comprising a porous SiO₂ anti-reflection layer, which comprises applying a self-adhesive protective film according to claim 1 to said glass surfaces.

12. The self-adhesive protective film of claim 1, wherein the amount of vinyl acetate in the polyethylene-vinyl acetate is at least 40% by weight.

13. The self-adhesive protective film of claim 12, wherein said amount of vinyl acetate is from 55 to 70% by weight.

14. The self-adhesive protective film of claim 3, wherein said amount of EVA is from 75 to 95%.

15. The self-adhesive protective film of claim 3, wherein said EVA has a VA fraction of from 50 to 65% by weight.

16. The self-adhesive protective film of claim 3 wherein said melt index is from 1 to 5 g/10 min.

17. The self-adhesive protective film of claim 3, wherein said amount of said polyether is from 5 to 20% by weight.

18. The self-adhesive protective film of claim 3, wherein said weight average molecular weight M_{w} is 1,000 to 20,000 g/mol.

19. The self-adhesive protective film of claim 5, wherein said amount of polybutylene glycol and/or polypropylene glycol is from 8 to 15% by weight.

20. The self-adhesive protective film of claim 7, wherein said amount of light stabilizers is at least 0.30% by weight.

21. The self-adhesive protective film of claim 8, wherein said backing film thickness is from 35 to 80 μm.

22. The self-adhesive protective film of claim 8, wherein said ethylene fraction is from 4 to 8% by weight.

23. The self-adhesive protective film of claim 8, wherein said amount of light stabilizer is more than 0.5% by weight.

24. The self-adhesive protective film of claim 10, wherein said coating weight is from 10 to 30 g/m².

25. A method of protecting glass surfaces comprising a porous SiO₂ anti-reflection layer, which comprises applying a self-adhesive protective film according to claim 2 to said glass surfaces.
